(19) United States
(12) Patent Application Publication
(10) Pub. No.: US 2005/0123723 A1
(43) Pub. Date: Jun. 9, 2005

(54) Grip strip and method of making the same

(76) Inventor: Jack Wang, Taichung Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 10/725,406

(22) Filed: Dec. 3, 2003

(51) Int. Cl. B32B 3/10; B05D 3/02

(52) U.S. Cl. 428/140; 427/372.2; 427/430.1

(57) ABSTRACT

A grip strip is made by preparing a substrate sheet having a plurality of through holes through top and bottom sides thereof, and made from a first polymer, then dipping or coating the substrate sheet with a melt second polymer different from the first polymer such that the through holes of the substrate sheet are filled up and at least one of the top and bottom sides of the substrate sheet is covered by the second polymer, and then hardening the second polymer-covered substrate sheet.

### BACKGROUND OF THE INVENTION

1. Field of the Invention

The present invention relates to grip strips and, more particularly, to a grip strip fabrication method to make a grip strip by preparing a substrate sheet from a first polymer and then coating or dipping the substrate sheet with a second polymer.

2. Description of the Related Art

A grip strip is a strip to be wound round the handle of an apparatus, for example, tennis or badminton racket, golf club, kick scooter, bicycle, etc. Elastic materials, such as polyurethane (PU), Ethylene Vinyl Acetate (EVA), etc., are commonly used for making grip strips for the advantages of anti-slip, shock absorbing, and breathing.

A popularly used grip strip is comprised of a foamed EVA substrate and a PU covering attached on the surface of the foamed EVA substrate by glue and/or double-sided adhesive tape (the substrate may be embedded with a layer of non-woven fabric). Thus, the outer PU covering achieves the desired anti-slip function, and the EVA substrate achieves the desired shock-absorbing function (there are known grip strips that have the PU covering disposed at the inside and the EVA substrate disposed at the outside). Other polymers of similar physical properties may be used for making grip strips.

According to conventional designs, the thickness of a grip strip is the combined thickness of the substrate and the covering (and the added backing layer or reinforcing layer if any). If the EVA substrate and the PU covering commonly have the thickness of 1 mm, the thickness of the finished grip strip must be 2 mm. Therefore conventional grip strips are commonly thick. When wound round the handle of an apparatus, the grip strip does not cause a sense of beauty (if making the substrate and the covering thinner during fabrication, the finished grip strip cannot provide the desired elastic and shock-absorbing power). Further, grip strips made according to the prior art methods commonly use much material, resulting in a high manufacturing cost. The side-to-side bonding between the substrate and the covering cannot tightly secure the substrate and the covering together, and the two materials may easily be separated from each other from the border area.

### SUMMARY OF THE INVNEION

The present invention has been accomplished under the circumstances in view. It is the main object of the present invention to provide a grip strip fabrication method, which keeps the substrate and the coating material tightly bonded together without affecting the physical properties of the materials used.

It is another object of the present invention to provide a grip strip fabrication method, which reduces the consumption of materials and the manufacturing cost.

It is still another object of the present invention to provide a grip strip fabrication method, which minimizes the thickness of the grip strip without affecting the physical properties of the materials used.

To achieve these objects of the present invention, the grip strip fabrication method comprises the steps of: (a) preparing a substrate sheet made from a fist material, the substrate sheet having a plurality of through holes through top and bottom sides thereof, the first material being a polymer; (b) dipping or coating the substrate sheet with a melt second material such that the through holes of said substrate sheet are filled up and at least one of the top and bottom sides of the substrate sheet is covered by the second material, the second material being a polymer different from the first material; and (c) hardening the second material-covered substrate sheet.

### BRIEF DESCRIPTION OF THE DRAWINGS

FIG. 1 illustrates a grip strip fabrication flow according to the first embodiment of the present invention.

FIG. 2 is a perspective view of a meshed net member prepared during the first step according to the first embodiment of the present invention.

FIG. 3 is a perspective view of a substrate sheet produced after the second step according to the first embodiment of the present invention.

FIG. 4 is a perspective view of a semi-finished grip strip produced after the third step according to the first embodiment of the present invention.

FIG. 5 is a sectional view taken along line 5-5 of FIG. 4.

FIG. 6 is a sectional view of a grip strip made according to the second embodiment of the present invention.

FIG. 7 illustrates a grip strip fabrication flow according to the second embodiment of the present invention.

FIG. 8 is a schematic view showing the action of the third step according to the third embodiment of the present invention.

FIG. 9 is a perspective view of a semi-finished grip strip produced after the fourth step according to the third embodiment of the present invention.

FIG. 10 is a sectional view taken along line 10-10 of FIG. 9.

### DETAILED DESCRIPTION OF THE PREFERRED EMBODIMENTS

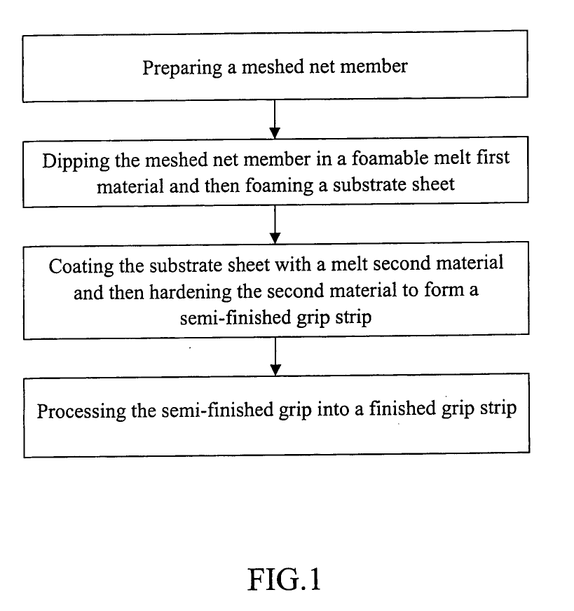

Referring to FIG. 1, a grip strip fabrication method in accordance with the first embodiment of the present invention includes the steps of (a) preparing a meshed net member, (b) dipping the meshed net member in a foamable melt first material and then foaming the first material-coated meshed net member into a substrate sheet, (c) coating the substrate sheet with a second material to form a semi-finished grip strip when hardened, and (d) processing the semi-finished grip strip into a finished grip strip. These steps are described hereinafter in detail.

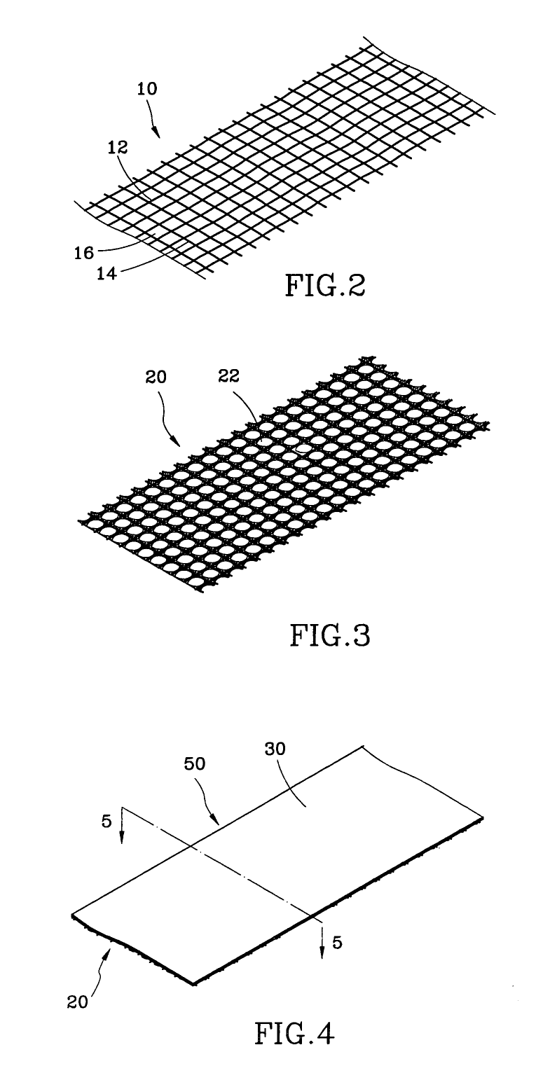

(a) As illustrated in FIG. 2, a meshed net member 10 formed of interwoven warp threads 12 and west threads 14 is firstly prepared. The warp threads 12 and the west threads 14 can be obtained from natural fibers, synthetic fibers, polymers, or metal. According to the present embodiment, the meshes 16 of the meshed net member 10 are orderly arranged in an array, having a rectangular shape of size about 5×4 mm.

(b) The meshed net member 10 thus obtained is dipped in a foamable melt first material, causing the warp threads 12 and the weft threads 14 to be evenly coated with a layer of the first material. According to this embodiment, the first material is EVA (Ethylene Vinyl Acetate). The EVA coating is then foamed. After foaming, a substrate sheet 20 is obtained (see FIG. 3). The substrate sheet 20 has a plurality of through holes 22 through the two opposite sides. According to this embodiment, the substrate sheet 20 has a meshed structure of thickness about 1 mm. The through holes 22 have an oval shape. The major axis and minor axis of the through holes 22 are about 4 mm and 3 mm respectively. The pitch between each two adjacent through holes 22 is about 1 mm.

(c) A stripping film (not shown; it is a smooth film commonly used in conventional grip strip fabrication methods) is attached to the bottom side of the substrate sheet 20, and then the top side of the substrate sheet 20 is coated with a layer of the second material, which is melted and fills up the through holes 22 of the substrate sheet 20, and then the top side (the coating of the second material) is flattened (this can easily be achieved by means of providing a scraper above the conveyer delivering the substrate sheet). According to the present embodiment, the second material is PU (Polyurethane). By means of PU's physical properties, the second material is tightly bonded to the substrate sheet 20 (EVA). After hardening of the second material (PU), the stripping film is removed from the substrate sheet 20, and therefore a semi-finished grip strip 50 is thus obtained, as shown in FIG. 4.

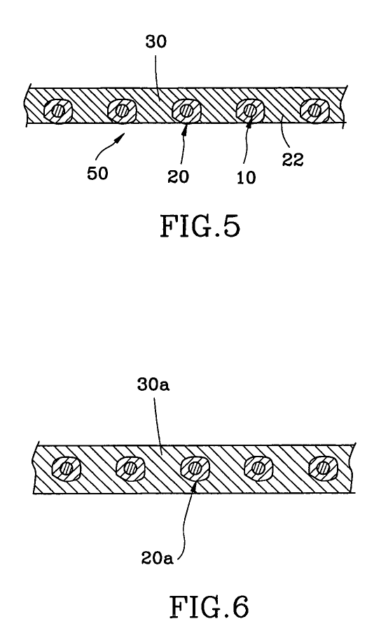

As shown in FIG. 5, the grip strip 50 comprises a substrate sheet 20, which is made from the aforesaid first material (EVA) and has through holes 22 through its two opposite sides, and a coating 30 obtained from the aforesaid second material (PU) and fixedly bonded to the substrate sheet 20 by coating on one side of the substrate sheet 20 and filling up the through holes 22. According to the present embodiment, the substrate sheet 20 contains a meshed net member 10, which reinforces the structural strength and stretching resilience of the substrate sheet 20.

(d) Basically, the aforesaid semi-finished grip strip 50 can be used as a grip strip (with the side of the coating material 30 facing the outside). In actual practice for commercialization, the semi-finished grip strip 50 must receive certain processing processes. These processing processes include: cutting the semi-finished grip strip 50 into individual grip strips subject to the desired width (the semi-finished grip strip 50 may be a strip of width about several times of the desired width), beveling the long sides of each individual strip (so that the finished grip strip can be wound round a device handle smoothly), embossing or stamping the surface of each individual grip strip to form a design, grinding each individual grip strip to coarsen the surface, and adhering a backing layer to the bottom side of each individual grip strip.

A grip strip made according to the aforesaid fabrication method has the physical properties of the first material (EVA) and the second material (PU), i.e., the properties of comfort gripping, anti-slip, and shock absorbing. In comparison to a conventional grip strip having two layers of different materials bonded together, a grip strip made according to the present invention has a relatively thinner thickness and consumes relatively fewer amounts of materials. Therefore, a grip strip made according to the present invention is good for application and has a relatively low manufacturing cost. Further, because the substrate and the coating material are interconnected with each other, they are tightly bonded together and will hardly separate from each other.

The aforesaid description is simply one example of the present invention. The materials used in the aforesaid embodiment of the present invention, i.e., EVA and PU are commonly used in conventional grip strips. Other polymers may be used to substitute for EVA and/or PU. The aforesaid substrate sheet 20, which is formed by dipping the meshed net member 10 in the first material and then proceeding to the foaming process, is a meshed structure of high resilience. In actual practice, other methods may be employed to make the desired substrate sheet. For example, directly punching through holes on a flat sheet member. There are no strict limitations on the shape, size and distribution of the through holes at the substrate sheet. Any arrangement of through holes that allow the second material to be evenly coated on the net member is acceptable. Further, the coating 30a may be coated on the both sides of the substrate sheet 20a, enhancing the bonding between the coating material and the substrate. According to this alternate form, the both sides of the grip strip are identical for convenient use. When making the grip strip shown in FIG. 6, the substrate 20a is dipped in the melt second material, and then second-material-coated substrate is set in shape from both sides.

As stated above, a backing layer may be bonded to the bottom side of the semi-finished grip strip to form any of a variety of grip strips. For example, a piece of non-woven fabric may be bonded to the back side of the semi-finished grip strip, and then the two long sides of the non-woven fabric-bonded semi-finished grip strip are beveled.

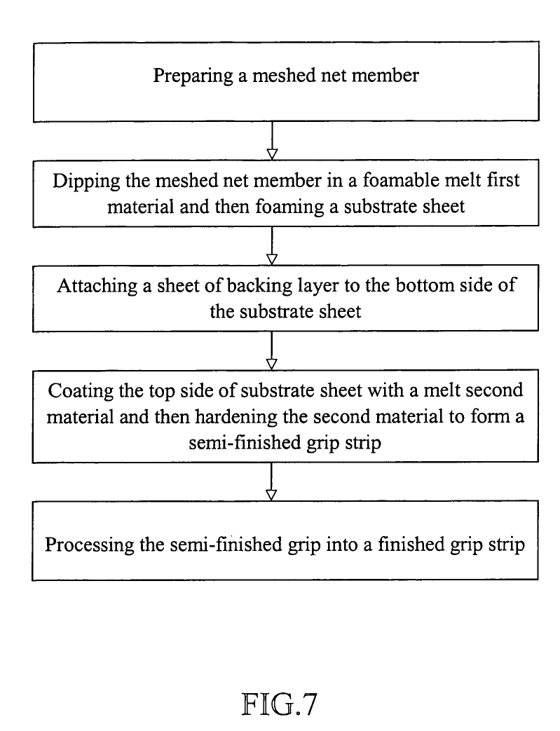

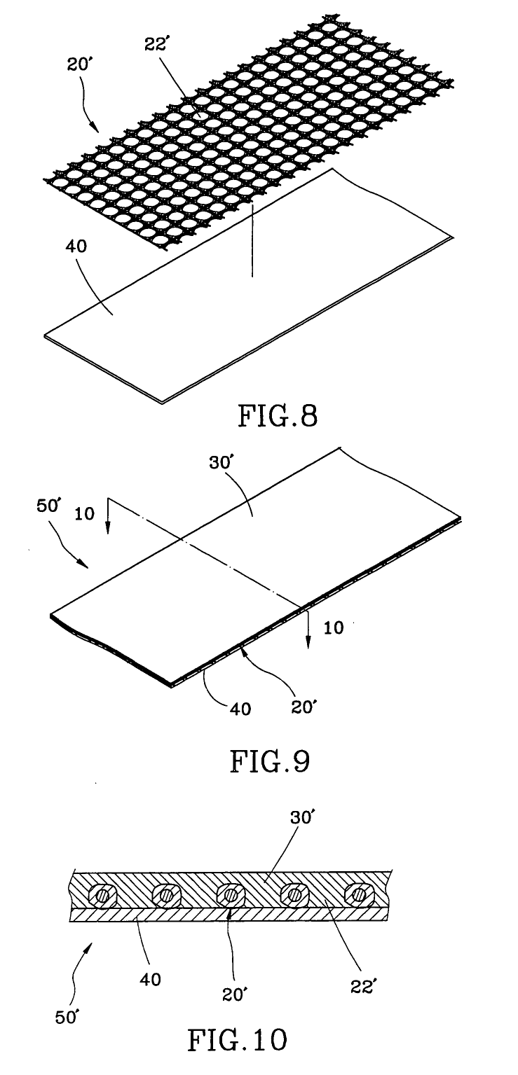

FIG. 7 indicates the third embodiment of the present invention. According to this embodiment, the grip strip fabrication method includes the steps of (a) preparing a meshed net member, (b) dipping the meshed net member in a melt first material and then foaming the first material-coated meshed net member into a substrate sheet, (c) attaching a sheet of backing material to the bottom side of the substrate sheet, (d) coating the top side of the substrate sheet with a melt second material to form a semi-finished grip strip when hardened, and (d) processing the semi-finished grip strip into a finished grip strip. According to this embodiment, steps (a) and (b) are same as the aforesaid first embodiment. Step (c) is outlined hereinafter with reference to FIG. 8. After fabrication of a substrate sheet 20′ having through holes 22′, put the substrate sheet 20′ on the top side of a non-woven backing material 40, and then coat the top side of the substrate sheet 20′ with a layer of the melt second material for enabling the through holes 22′ to be filled with the second material and bonded to the non-woven backing material 40, and thus a semi-finished grip strip 50′, as shown in FIGS. 9 and 10, is obtained when the second material is hardened. Because the second material is directly bonded to the non-woven backing material 40 when covered on the top side of the substrate sheet 20′, this embodiment eliminates the procedure of bonding the backing material to the substrate.

1. A grip strip fabrication method comprising the steps of:
(a) preparing a substrate sheet made from a fist material, said substrate sheet having a plurality of through holes through top and bottom sides thereof, said first material being a polymer;
(b) dipping or coating said substrate sheet with a melt second material such that said through holes of said substrate sheet are filled up and at least one of the top and bottom sides of said substrate sheet is covered by said second material, said second material being a polymer different from said first material;
(c) hardening the second material-covered substrate sheet.

2. The grip strip fabrication method as claimed in claim 1, wherein said first material is EVA (Ethylene Vinyl Acetate).

3. The grip strip fabrication method as claimed in claim 1, wherein said second material is PU (Polyurethane).

4. The grip strip fabrication method as claimed in claim 1, wherein said through holes are arranged in an array.

5. The grip strip fabrication method as claimed in claim 1, further comprising a step of dipping a meshed net member in melt said first material and then foaming the first material-coated meshed net member into said substrate sheet before the step (a).

6. The grip strip fabrication method as claimed in claim 1, wherein said through holes are punch holes punched on said substrate sheet.

7. The grip strip fabrication method as claimed in claim 1, wherein said second material is covered on only one of the top and bottom sides of said substrate sheet.

8. The grip strip fabrication method as claimed in claim 7, wherein one of the top and bottom sides of said substrate sheet without said second material is attached with a layer of backing material.

9. The grip strip fabrication method as claimed in claim 8, wherein said second material is covered on said substrate sheet after said layer of backing material has been attached to one of the top and bottom sides of said substrate sheet.

10. The grip strip fabrication method as claimed in claim 8, wherein said layer of backing material is selected from non-woven fabric.

11. The grip strip fabrication method as claimed in claim 1, wherein said second material is covered on both the top and bottom sides of said substrate sheet.

12. A grip strip comprising:
a substrate sheet having a plurality of through holes through top and bottom sides thereof, sad substrate being made from a first material of polymer; and
a coating covered on at least one of the top and bottom sides of said substrate sheet and filled up said through holes, said coating being made from a second material of polymer different from said first material of polymer.

13. The grip strip as claimed in claim 12, wherein said first material is EVA (Ethylene Vinyl Acetate).

14. The grip strip as claimed in claim 12, wherein said second material is PU (Polyurethane).

15. The grip strip as claimed in claim 12, wherein said through holes are arranged in an array.

16. The grip strip as claimed in claim 15, wherein said substrate sheet comprises a meshed net member formed of interwoven warp threads and weft threads, said meshed net member having meshes corresponding to said through holes.

17. The grip strip as claimed in claim 12, wherein said coating is covered on only one of the top and bottom sides of said substrate sheet.

18. The grip strip as claimed in claim 17, wherein one of the top and bottom sides of said substrate sheet without said coating is attached with a layer of backing material.

19. The grip strip as claimed in claim 18, wherein said layer of backing material is made from non-woven fabric.

20. The grip strip as claimed in claim 12, wherein said coating is covered on both the top and bottom sides of said substrate sheet.
